(19) United States
(12) Patent Application Publication
(10) Pub. No.: US 2020/0314107 A1
(43) Pub. Date: Oct. 1, 2020

(54) SYSTEMS, METHODS, AND MEDIA FOR SECURING INTERNET OF THINGS DEVICES

(71) Applicant: McAfee, LLC, Santa Clara, CA (US)

(72) Inventors: Harsha R. Joshi, Bangalore (IN); Tirumaleswar Reddy Konda, Bengaluru (IN); Shashank Jain, Bangalore (IN); Abhishek Tripathi, Bangalore (IN)

(21) Appl. No.: 16/429,974

(22) Filed: Jun. 3, 2019

(30) Foreign Application Priority Data
Mar. 29, 2019 (IN) 201911012569

(51) Int. Cl. H04L 29/06; H04L 29/08; H04L 29/12

(52) U.S. Cl. CPC H04L 63/105; H04L 67/12; H04L 63/20; H04L 61/1511; H04L 67/143

(57) ABSTRACT

Mechanisms (which can include systems, methods, and media) for securing an Internet of Things (IoT) device are provided, the mechanisms comprising: receiving a DNS request identifying a fully qualified domain name (FQDN) that originated from the IoT device; in response to receiving the DNS request, determining by a hardware processor whether to allow or drop a connection between the IoT device and a target domain corresponding to the FQDN; and responding to the DNS request with instructions to allow or drop the connection based on the determining.

### CROSS-REFERENCE TO RELATED APPLICATION

This application claims the benefit of Indian Provisional Patent Application No. 201911012569, filed Mar. 29, 2019, which is hereby incorporated by reference herein in its entirety.

### BACKGROUND

With recent rapid growth in the popularity of Internet of Things (IoT) devices, it has become normal for a consumer to have a multitude of connected devices in their home. These devices can range from smart consumer appliances (like televisions, refrigerators, ovens, microwaves) to smart lighting devices, smart cameras, smart thermostats, smart locks, smart door bells, smart door openers, personal assistant devices (like GOOGLE HOME HUB and AMAZON ECHO), and common household items with integrated circuits to make them smart.

Usually, IoT devices are always connected to the Internet (or connect to the Internet frequently) to communicate with external servers (e.g., IoT gateways). These devices may communicate with external servers to update their status or get programmed by the external servers. In some instances, users can access and program the devices directly or via the external server.

However, with this rapid growth, the security of the smart home has decreased significantly. Some reasons for this are that: many IoT devices have not been designed with a security focus; once deployed, many IoT devices are rarely updated; unlike a personal computer or a mobile phone, many IoT devices are headless, and it becomes extremely difficult to detect if someone has taken control of the devices and even harder to mitigate such control; and with many IoT devices in a single home network, it is very hard for a consumer to manage security of the IoT devices.

As a result of these security limitations, IoT devices have become a primary target of cyber-attacks on smart homes, which has the potential to lead to a severe loss of digital and physical assets.

Accordingly, there is a need for new systems, methods, and media for securing IoT devices.

### SUMMARY

In accordance with some embodiments, systems, methods, and media for securing IoT devices are provided. In some embodiments, systems for securing an Internet of Things (IoT) device, comprising: a memory; and a hardware processor that is coupled to the memory and that is configured to: receive a DNS request identifying a fully qualified domain name (FQDN) that originated from the IoT device; in response to receiving the DNS request, determine whether to allow or drop a connection between the IoT device and a target domain corresponding to the FQDN; and respond to the DNS request with instructions to allow or drop the connection based on the determining.

In some embodiments, methods for securing an Internet of Things (IoT) device are provided, the methods comprising: receiving a DNS request identifying a fully qualified domain name (FQDN) that originated from the IoT device; in response to receiving the DNS request, determining by a hardware processor whether to allow or drop a connection between the IoT device and a target domain corresponding to the FQDN; and responding to the DNS request with instructions to allow or drop the connection based on the determining.

A non-transitory computer-readable medium containing computer executable instructions that, when executed by a processor, cause the processor to perform a method for securing an Internet of Things (IoT) device are provided, the method comprising: receiving a DNS request identifying a fully qualified domain name (FQDN) that originated from the IoT device; in response to receiving the DNS request, determining whether to allow or drop a connection between the IoT device and a target domain corresponding to the FQDN; and responding to the DNS request with instructions to allow or drop the connection based on the determining.

### BRIEF DESCRIPTION OF THE DRAWINGS

FIG. 1 illustrates an example of hardware that can be used in accordance with some embodiments.

FIG. 2 illustrates a more particular example of hardware that can be used for certain components of the hardware of FIG. 1 in accordance with some embodiments.

FIGS. 3A and 3B illustrate an example of a process for determining whether to allow, drop, or inspect connections between IoT devices and domains in accordance with some embodiments.

### DETAILED DESCRIPTION

In accordance with some embodiments, mechanisms (which can include systems, methods, and media) for securing Internet of Things (IoT) devices are provided. In some embodiments, the mechanisms operate by determining at a server remote from a consumer's network whether to allow, drop, or inspect connections between the IoT devices and remote domains, and then by instructing a router in the consumer's network to create and apply rules to allow, drop, or inspect those connections.

Connections can be determined as to be allowed, dropped, or inspected based upon any suitable criteria or criterion. For example, in some embodiments, a reputation of a domain to be connected to by an IoT device (a “target domain”) can be evaluated so that connections between the target domain and the IoT device can be dropped when it is determined that the target domain's reputation is bad.

As another example, in some embodiments, when an IoT device has a known type and manufacturer, and a target domain is owned by the manufacturer of the IoT device, connections between the IoT device and the target domain can be allowed and the target domain can be added to a white-list for the type and manufacturer.

As another example, in some embodiments, when an IoT device has a known type and manufacturer, and there is a common domain name and/or category of domains that are frequently connected to by IoT devices of that type and manufacturer, connections between the IoT device and a target domain matching that common domain name and/or category of domains can be allowed and the target domain and/or its categories can be added to a white-list of domain names and/or categories of domains for that type and manufacturer of IoT device.

As still another example, in some embodiments, when an IoT device has a known type, and there is a common category of domains that is frequently connected to by IoT devices of that type, connections between the IoT device and a target domain matching that common category of domains can be allowed and the categories of the target domain can be added to a white-list of categories of domains for that type of IoT device.

As yet another example, in some embodiments, when the type of an IoT device is not known, or the type is known but there is no common category of domains for the type of IoT device, connections between that IoT device and a target domain can be configured to be allowed until the IoT device can be identified using some alternate means like traffic pattern analysis, DNS profiling, etc.

As still another example, in some embodiments, when the type of an IoT device is not known, or the type is known but there is no common category of domains for the type of IoT device, connections between that IoT device and a target domain can be configured to be inspected and deep packet inspection (DPI) can be applied to figure out if the traffic is good or bad.

As yet another example, in some embodiments, when an IoT device has a known type, manufacturer, and model, and a target domain is in a white-list for the known type, manufacturer, and model, connections between the IoT device and the target domain can be allowed.

As still another example, in some embodiments, when an IoT device has a known type, manufacturer, and model, and a domain category (such as illegal drugs, alcohol, pornography, etc.) of a target domain is in a black-list, connections between the IoT device and the target domain can be dropped.

As yet another example, in some embodiments, when an IoT device has a known type, manufacturer, and model, and a domain category of a domain is in a white-list for the known type, manufacturer, and model, connections between the IoT device and the target domain can be allowed.

As still another example, in some embodiments, when an IoT device has a known type, manufacturer, and model, the target domain can be evaluated to determine whether its category of domains is relevant to the IoT device, behavioral analysis can be performed on connections to the target domain, and a score calculated, and, if the score is in a white-list range, then connections between the IoT device and the target domain can be allowed and the target domain can be added to a white-list for the type, manufacturer, and model.

As yet another example, in some embodiments, when an IoT device has a known type, manufacturer, and model, the target domain can be evaluated to determine whether its category is relevant to the IoT device, behavioral analysis can be performed on connections to the target domain, and a score calculated, and, if the score is in a gray-list range, then connections between the IoT device and the target domain can be inspected.

As still another example, in some embodiments, when an IoT device has a known type, manufacturer, and model, the target domain can be evaluated to determine whether its category of domains is relevant to the IoT device, behavioral analysis can be performed on connections to the target domain, and a score calculated, and, if the score is in a black-list range, then connections between the IoT device and the target domain can be dropped.

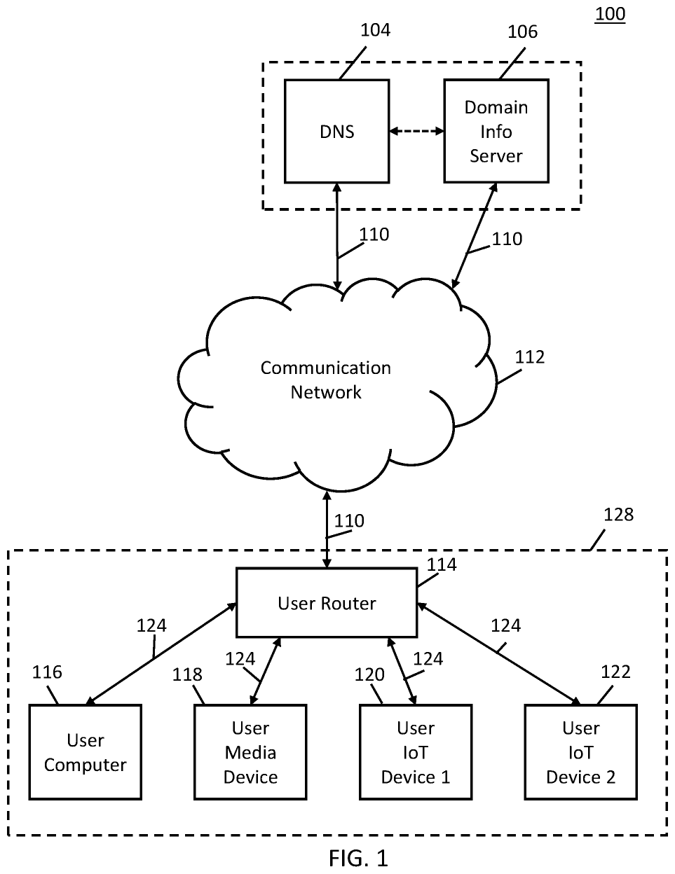

Turning to FIG. 1, an example 100 of hardware for securing Internet of Things (IoT) devices in accordance with some embodiments of the disclosed subject matter is shown. As illustrated, hardware 100 can include a Domain Name Server (DNS) 104, a domain information server 106, a communication network 112, a user router 114, a user computer 116, a user media device 118, and user Internet-of-Things (IoT) devices 120 and 122.

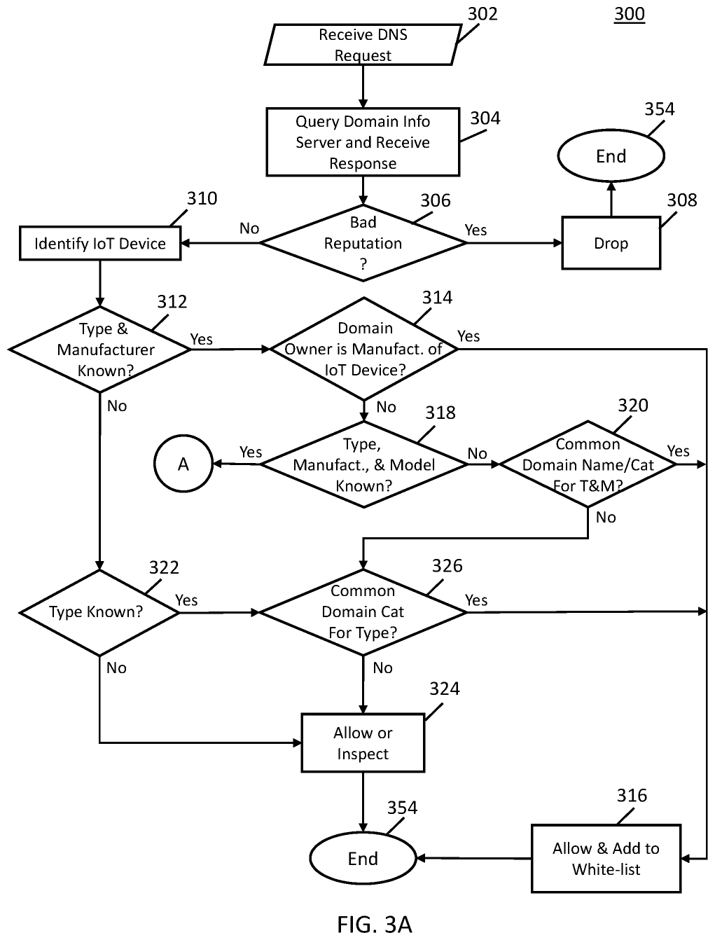

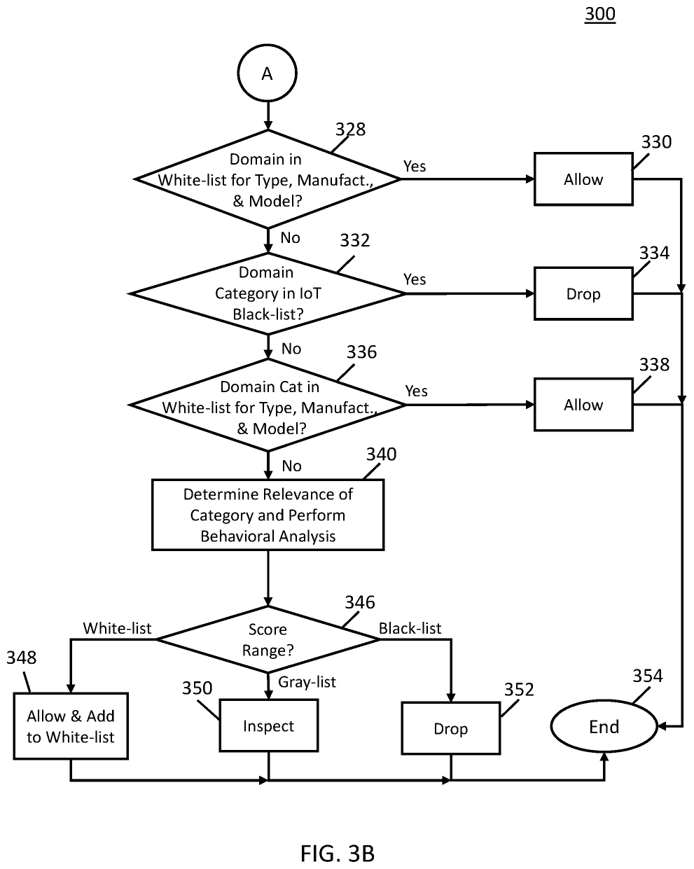

DNS 104 can any suitable domain name server. In some embodiments, DNS 104 can also be configured to execute a process like that described below in connection with FIG. 3. In some embodiments, the process of FIG. 3 can be executed by a server other than DNS 104, such as a server not shown in FIG. 1 or domain information server 106.

Domain information server 106 can be any suitable server for gathering and distributing domain information. For example, in some embodiments, domain information server can gather and distribute information on domains such as a reputation score for each domain, one or more categories associated with each domain, and/or any other suitable information. In some embodiments, domain information server 106 can be configured to distribute feeds of network meta-information associated with a fully quantified domain name (FQDN) to DNS 104.

In some embodiments, DNS 104 and domain information server 106 can be implemented on a common network, platform, or device and a direct link (such as network link, dial-up link, wireless link, hard-wired link, any other suitable communications link, or any suitable combination of such links) can be provided between them.

In some embodiments, DNS messages (such as a DNS request and a DNS response) can be routed by user router 114 between one or more of user computer 116, user media device 118, and user IoT devices 120 and 122 and DNS 104.

Communication network 112 can be any suitable combination of one or more wired and/or wireless networks in some embodiments. For example, in some embodiments, communication network 112 can include any one or more of the Internet, a mobile data network, a satellite network, a local area network, a wide area network, a telephone network, a cable television network, a WiFi network, a WiMax network, and/or any other suitable communication network.

In some embodiments, communication network 112 and the devices connected to it can form or be part of a wide area network (WAN).

DNS 104, domain information server 106, and user router 114 can be connected by one or more communications links 110 to communication network 112. The communications links can be any communications links suitable for communicating data among DNS 104, domain information server 106, user router 114, and communication network 112, such as network links, dial-up links, wireless links, hard-wired links, any other suitable communications links, or any suitable combination of such links.

User router 114 can be any suitable router. In some embodiments, a DNS stub resolver on user router 114 can add an EDNS option to DNS requests to be sent, requesting DNS 104 to provide instructions on how to handle (e.g., allow, inspect, or drop) a connection between an IoT device and a domain. Based on these instructions, user router 114 can create one or more firewall rules that can determine whether current and/or future connections between an IoT device and a target domain are to be allowed, inspected and/or dropped.

User computer 116 can be any suitable computer, such as a desktop computer, a laptop computer, a tablet computer, a smart phone, and/or any other suitable computer device.

User media device 118 can be any suitable device for streaming media, such as a media player box, a media player dongle (which can stream video and audio, video only, or audio only), a smart television, etc.

User IoT devices 120 and 122 can be any suitable Internet of Things devices, such as internet protocol cameras, smart smoke alarms, smart thermostats, smart locks, alarms, sensors, light bulbs, hubs, smart speakers, and/or any other device that can be connected to a computer network.

User computer 116, user media device 118, and user IoT devices 120 and 122 can be connected by one or more communications links 124 to user router 114. The communications links can be any communications links suitable for communicating data among user computer 116, user media device 118, user IoT devices 120 and 122, user router 114, such as network links, dial-up links, wireless links, hard-wired links, any other suitable communications links, or any suitable combination of such links.

In some embodiments, user computer 116, user media device 118, user IoT devices 120 and 122, communications links 124, and user router 114 can form or be part of a local area network 128.

Although only one DNS 104, one domain information server 106, one user router 114, one user computer 116, one user media device 118, and two user IoT devices 120 and 122 are shown in FIG. 1 to avoid over-complicating the figure, any suitable numbers (including zero in some embodiments) of these devices can be used in some embodiments.

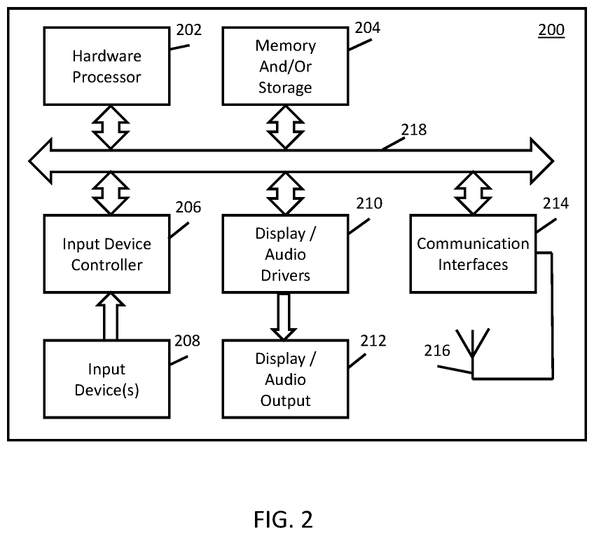

DNS 104, domain information server 106, user router 114, user computer 116, user media device 118, and/or user IoT devices 120 and 122 can be implemented using any suitable hardware in some embodiments. For example, in some embodiments, DNS 104, domain information server 106, user router 114, user computer 116, user media device 118, and/or user IoT devices 120 and 122 can be implemented using any suitable general-purpose computer or special-purpose computer. For example, a user IoT device can be implemented using a special-purpose computer. Any such general-purpose computer or special-purpose computer can include any suitable hardware. For example, as illustrated in example hardware 200 of FIG. 2, such hardware can include hardware processor 202, memory and/or storage 204, an input device controller 206, an input device 208, display/audio drivers 210, display and audio output circuitry 212, communication interface(s) 214, an antenna 216, and a bus 218.

Hardware processor 202 can include any suitable hardware processor, such as a microprocessor, a micro-controller, digital signal processor(s), dedicated logic, and/or any other suitable circuitry for controlling the functioning of a general-purpose computer or a special purpose computer in some embodiments.

Memory and/or storage 204 can be any suitable memory and/or storage for storing programs, data, and/or any other suitable information in some embodiments. For example, memory and/or storage 204 can include random access memory, read-only memory, flash memory, hard disk storage, optical media, and/or any other suitable memory.

Input device controller 206 can be any suitable circuitry for controlling and receiving input from a device in some embodiments. For example, input device controller 206 can be circuitry for receiving input from a touch screen, from one or more buttons, from a voice recognition circuit, from a microphone, from a camera, from an optical sensor, from an accelerometer, from a temperature sensor, from a near field sensor, and/or any other type of input device.

Display/audio drivers 210 can be any suitable circuitry for controlling and driving output to one or more display/audio output circuitries 212 in some embodiments. For example, display/audio drivers 210 can be circuitry for driving an LCD display, a speaker, an LED, or any other type of output device.

Communication interface(s) 214 can be any suitable circuitry for interfacing with one or more communication networks, such as network 112 as shown in FIG. 1. For example, interface(s) 214 can include network interface card circuitry, wireless communication circuitry, and/or any other suitable type of communication network circuitry.

Antenna 216 can be any suitable one or more antennas for wirelessly communicating with a communication network in some embodiments. In some embodiments, antenna 216 can be omitted when not needed.

Bus 218 can be any suitable mechanism for communicating between two or more components 202, 204, 206, 210, and 214 in some embodiments.

Any other suitable components can additionally or alternatively be included in hardware 200 in accordance with some embodiments.

Turning to FIGS. 3A and 3B, an example 300 of a process for determining whether to allow, drop, or inspect connections between IoT devices and target domains in accordance with some embodiments is shown. Process 300 can be executed by any suitable one or more devices, such as DNS 104.

As illustrated, process 300 begins at 302 by receiving a DNS request. This DNS request can be received in any suitable manner, can have any suitable content, and can be in any suitable format in some embodiments. For example, the DNS request can be received from user router 114, can identify a fully qualified domain name (FQDN), and can include an EDNS option requesting instructions on how to handle connections between an IoT device and a target domain corresponding to the FQDN.

Next, at 304, process 300 can query domain information server for meta information for the target domain associated with the FQDN and receive a response including the meta information. The meta information can include any suitable information in some embodiments. For example, the meta information can include reputation information and category information in some embodiments.

Then, at 306, process 300 can determine whether the target domain for the FQDN has a bad reputation in some embodiments. This determination can be made in any suitable manner and can be based on any suitable criterion or criteria. For example, in some embodiments a reputation score received at 304 can be compared to a threshold to determine if the target domain has a bad reputation. Any suitable threshold can be used in some embodiments.

If it is determined at 306 that the target domain has a bad reputation, then, at 308, process 300 can respond to the DNS request with an EDNS option that instructs user router 114 to drop the connection corresponding to the DNS request. In some embodiments, any suitable response can be provided to the device that issued the DNS request, such as a message indicating that the target domain has a bad reputation. In response to receiving instructions to drop the connection between the IoT device and the target domain, the user router can create a rule to drop all such connections between the IoT device and the target domain in some embodiments.

Otherwise, if it is determined at 306 that the domain does not have a bad reputation (including that the reputation cannot be determined), then process 300 can attempt to identify the IoT device originating the DNS request at 310. Process 300 can attempt to identify the IoT device in any suitable manner, and any suitable amount of information can be determined for the IoT device in some embodiments. For example, a fingerprint of the IoT device can be taken and the fingerprint can be used to identify the type, manufacturer, model, operating system, operating system version, firmware version, and/or any other suitable identifying information. For example, NEST generation 3 thermostat could have type “Thermostat,” a manufacturer “Nest,” and a model “Generation 3.” As another example, a BELKIN NetCam HD surveillance camera could have a type “Camera,” a manufacturer “BELKIN,” and a model “NetCam HD.” In some embodiments, a fingerprint of an IoT device can be taken in any suitable manner, such as by observing the MAC address of the device, a host name of the device, responses to network discovery probes like UpnP, MDNS (Bonjour), NetBIOS, SNMP, etc., open ports on the device, user agents used by the device, DNS requests made by the device, DHCP vendor and vendor options used by the device, and network characteristics (e.g., domains visited, content of packets sent/received, interpacket arrival rate, TTL, etc.) of the device, and/or any other observable traits of the device.

Next, at 312, process 300 can determine whether the type and manufacturer for the IoT device are known. This determination can be made in any suitable manner in some embodiments. For example, process 300 can determine that each of the type and the manufacturer for the IoT device are known when identifiers for each are returned with suitable confidence at 310.

If it is determined at 312 that the type and manufacturer for the IoT device are known, then, at 314, process 300 can determine whether the owner of the target domain is the manufacturer of the IoT device. This determination can be made in any suitable manner in some embodiments. For example, in some embodiments, process 300 can determine that the owner of the target domain is the manufacturer of the IoT device by querying a database identifying manufacturers of the different IoT devices (which can be identified by type, manufacturer, and model), receiving a list of one or more entities that own domains corresponding to the manufacturer of the IoT device, and determining if there is a match between the entities recited in the list and an entity publicly identified as the owner of the domain in a publicly accessible database, such as a database maintained by ICANN.

If process 300 determines at 314 that the owner of the target domain is the manufacturer of the IoT device, then, at 316, process 300 can respond to the DNS request with an EDNS option that instructs user router 114 to allow the connection corresponding to the DNS request and process 300 can add the domain to a white-list for the known type and manufacturer of IoT device. In response to receiving instructions to allow the connection between the IoT device and the target domain, the user router can create a rule to allow all such connections between the IoT device and the target domain in some embodiments.

Otherwise, if process 300 determines at 314 that the owner of the target domain is not the manufacturer of the IoT device, then, at 318, process 300 can then determine whether the type, manufacturer, and model for the IoT device are known. This determination can be made in any suitable manner in some embodiments. For example, process 300 can determine that each of the type, the manufacturer, and the model for the IoT device are known when identifiers for each are returned with suitable confidence at 310.

If it is determined at 318 that the type, manufacturer, and model for the IoT device are not known, then, at 320, process 300 can determine whether the target domain and/or category associated with the target domain is the same as a domain and/or a category associated with a domain, respectively, frequently connected to by IoT devices of the known type and manufacturer. This determination can be made in any suitable manner. For example, a database of showing domains and/or categories of domains accessed by IoT devices of different types and different manufacturers can be accessed to determine what domains and/or categories of domains are accessed by IoT devices matching the known type and known manufacturer. A domain and/or category of domains can be determined to be frequently connected to by an IoT device when a ratio of the connections by that device to the domain and/or the category of domains to all connections by that IoT device exceeds a given threshold (e.g., 1:1, 1:2: 2:3, 3:4, 4:5, and/or any other suitable ratio).

If it is determined at 320 that the target domain and/or a category associated with the target domain is the same as a domain and/or a category associated with a domain, respectively, frequently connected to by IoT devices of the known type and manufacturer, then, at 316, process 300 can respond to the DNS request with an EDNS option that instructs user router 114 to allow the connection corresponding to the DNS request and process 300 can add the domain to a white-list for the known type and manufacturer. In response to receiving instructions to allow the connection between the IoT device and the target domain, the user router can create a rule to allow all such connections between the IoT device and the target domain in some embodiments.

Otherwise, if it is determined at 312 that the type and the manufacturer of the IoT device are not known, then, at 322, process 300 can determine whether the type of the IoT device is known. This determination can be made in any suitable manner in some embodiments. For example, process 300 can determine that the type of the IoT device is known when an identifier for the type is returned with suitable confidence at 310.

If it is determined at 322 that the type of the IoT device is known, or if it is determined at 320 that the target domain and/or a category associated with the target domain is not the same as a domain and/or a category associated with a domain, respectively, frequently connected to by IoT devices of the known type and manufacturer, then, at 326, process 300 can determine whether a category associated with the target domain is the same as a category associated with a domain frequently connected to by IoT devices of the known type. This determination can be made in any suitable manner. For example, a database showing categories of domains accessed by IoT devices of different types can be accessed to determine what categories of domains are accessed by IoT devices matching the known type. A category of domain can be determined to be frequently connected to by an IoT device when a ratio of the connections by that device to the category of domain to all connections by that IoT device exceeds a given threshold (e.g., 1:1, 1:2: 2:3, 3:4, 4:5, and/or any other suitable ratio).

If it is determined at 326 that a category associated with the target domain is the same as a category associated with a domain frequently connected to by IoT devices of the known type, then, at 316, process 300 can respond to the DNS request with an EDNS option that instructs user router 114 to allow the connection corresponding to the DNS request and process 300 can add the domain to a white-list for the known type. In response to receiving instructions to allow the connection between the IoT device and the target domain, the user router can create a rule to allow all such connections between the IoT device and the target domain in some embodiments.

Otherwise, if it is determined at 322 that the type of the IoT is not known or if it is determined at 326 that a category associated with the target domain is not the same as a category associated with a domain frequently connected to by IoT devices of the known type, then, at 324, process 300 can respond to the DNS request with an EDNS option that instructs user router 114 to: (1) allow connections between that IoT device and a target domain until the IoT device can be identified using some alternate means like traffic pattern analysis, DNS profiling, etc.; or (2) inspect connections between that IoT device and a target domain using deep packet inspection (DPI) to figure out if the traffic is good or bad.

Otherwise, if it is determined at 318 that the type, manufacturer, and model for the IoT device are known, then, at 328 (FIG. 3B), process 300 can determine whether the target domain is in a white-list for the type, manufacturer, and model of the IoT device. This determination can be made in any suitable manner in some embodiments. For example, in some embodiments, this determination can be made by querying a device type, manufacture, model, white-list domain repository to determine if the target domain is identified as belonging to the white-list.

If it is determined at 328 that the target domain is in a white-list for the type, manufacturer, and model of the IoT device, then at 330 process 300 can respond to the DNS request with an EDNS option that instructs user router 114 to allow the connection corresponding to the DNS request. In response to receiving instructions to allow the connection between the IoT device and the target domain, the user router can create a rule to allow all such connections between the IoT device and the target domain in some embodiments.

Otherwise, if it is determined at 328 that the target domain is not in a white-list for the type, manufacturer, and model of the IoT device, then, at 332, process 300 can determine whether a category of domains for the target domain is in an IoT black-list. This determination can be made in any suitable manner in some embodiments. For example, in some embodiments, this determination can be made by querying a category of domains black-list. More particularly, process 300 can look-up a category of domains corresponding to the target domain in a domain category black-list to determine if the domain category is listed therein, and, if so, can consider the domain category to be black-listed. In some embodiments, a global IoT category of domains black-list can contain a set of categories that are expected to never be seen in an allow-list for any IoT device (e.g., categories related to adult topics, actual or potential criminal activities, illegal drugs, discrimination, nudity, etc.).

If process 300 determines at 332 that the category of domains for the target domain is in an IoT black-list, then, at 334, process 300 can respond to the DNS request with an EDNS option that instructs user router 114 to drop the connection corresponding to the DNS request. In some embodiments, any suitable response can be provided to the device that issued the DNS request, such as a message indicating that the target domain has a category that is in a black-list. In response to receiving instructions to drop the connection between the IoT device and the target domain, the user router can create a rule to drop all such connections between the IoT device and the target domain in some embodiments.

Otherwise, if process 300 determines at 332 that the category of domains for the target domain is not in an IoT black-list, then, at 336, process 300 can determine whether the category of domains for the target domain is in an IoT white-list for the type, manufacturer, and model of the IoT device. This determination can be made in any suitable manner in some embodiments. For example, in some embodiments, this determination can be made by querying a category of domains white-list with the type, manufacturer, and model of the IoT device to determine if the category of domains for the target domain is listed therein, and, if so, can consider the category of domains for the target domain to be white-listed.

If process 300 determines at 336 that a category of domains for the target domain is in an IoT white-list for the type, manufacturer, and model of the IoT device, then, at 338, process 300 can respond to the DNS request with an EDNS option that instructs user router 114 to allow the connection corresponding to the DNS request. In response to receiving instructions to allow the connection between the IoT device and the target domain, the user router can create a rule to allow all such connections between the IoT device and the target domain in some embodiments.

Otherwise, if process 300 determines at 336 that a category of domains for the target domain is not in an IoT white-list for the type, manufacturer, and model of the IoT device, then, at 340, process 300 can determine the relevance of a category of domains of the target domain to the IoT device, perform a behavioral analysis on communications on the connection, and produce a score for the target domain for the type, manufacturer, and model of the IoT device.

The relevance of a category of domains of the target domain to the IoT device can be determined in any suitable manner in some embodiments. For example, in some embodiments, domain category descriptions (e.g., which can each be a text-based description of a category) can be used to compute similarity between a category of a domain that an IoT device is attempting to connect to and categories of domains frequently connected to by similar devices. The similarity of the categories can be computed in any suitable manner in some embodiments. For example, in some embodiments, word embedding can be used to convert word or phrases from the domain category descriptions to vectors or real numbers and then these vectors for different descriptions can be compared using any suitable technique. For example, in some embodiments, Word2vec, GloVe, or any other suitable technique can be used to convert words and/or phases to vectors, and a K-nearest neighbor approach can be used to compare the vectors to determine if a domain category description corresponding to a domain being inspected is more like domain category descriptions describing categories of domains in a white list or categories of domains in a black-list. As another example, instead of using a K-nearest neighbor approach as described in the previous example, a Word Mover's Distance function (as described in Kusner et. al, “From Word Embeddings to Document Distances,” Proceedings of the 32nd International Conference on Machine Learning, Lille, France, 2015, JMLR: W&CP, volume 37, which is hereby incorporated by reference herein in its entirety) can be used to compare the vectors to determine if a domain category description corresponding to a domain being inspected is more like domain category descriptions describing categories of domains in a white list or categories of domains in a black-list.

In some embodiments, the relevance of a category can be reflected as a relevance score. This score can have any suitable range of values in some embodiments. For example, in some embodiments, the relevance score can range from 0 (completely irrelevant) to 100 (completely relevant).

The behavioral analysis on communications on the connection can be performed in any suitable manner in some embodiments. For example, in some embodiments, analytics and/or machine learning techniques can be used to inspect telemetry data (e.g., 5 tuple (source IP address, destination IP address, source port, destination port, and protocol), inter packet arrival rate, packet byte ratio, domain frequency, time interval, etc.) from similar IoT devices across multiple LANs to determine whether the communications on the connection are anomalous. In some embodiments, the behavior analysis can be reflected as a behavior score. This score can have any suitable range of values in some embodiments. For example, in some embodiments, the behavior score can range from 0 (completely anomalous) to 100 (completely normal).

Any suitable behavioral analysis techniques can be used in some embodiments. For example, in some embodiments, machine learning techniques can be used to classify domains into a white-list (connections to be allowed), gray-list (connections to be inspected), or black-list (connections to be dropped). These machine learning techniques can be trained using any suitable training data, can be implemented as off-line or on-line, and can be supervised or unsupervised in some embodiments.

As another example, in some embodiments, data can be collected for the IoT device when first detected to determine its normal behavior over an initial period of time. This normal behavior can include ranges of number of visits to a domain per day, minimum and maximum time interval between visits to same domain, etc. for the IoT device in some embodiments. Deviations from normal activity can result in the behavior being scored as anomalous.

As yet another example, in some embodiments, ping domains (e.g., domains that are just used for connectivity checks and that do not have any functional or behavioral impact) for all or a large number of IoT devices can be monitored and pings by an IoT device to a domain other than a normal ping domain can be scored as anomalous.

In accordance with some embodiment, telemetry data can be collected for the target domain in any suitable manner. For example, deep packet inspection (DPI) can be performed on the traffic to a domain in some embodiments. More particularly, for example, in some embodiments, for encrypted traffic, DPI can be used to extract traffic flow telemetry such as sequence of packet lengths, inter-packet arrival rate, byte distribution, etc. in addition to transport layer security (TLS) meta data.

The score for the target domain for the type, manufacturer, and model of the IoT device can be produced in any suitable manner in some embodiments. For example, in some embodiments, the score can be a weighted combination of the relevance score and the behavior. More particularly, for example, the score can be calculated by:

Score=Weight_{relevance}*Score_{relevance}+Weight_{behavior}*Score_{behavior}

wherein: Weight_{relevance} is the weight of the relevance score and is a number between 0 and 1;

Score_{relevance} is the score associated with the relevance analysis;

Weight_{behavior} is the weight of the behavior score and is a number between 0 and 1;

Score_{behavior} is the score associated with the relevance analysis; and

Weight_{relevance} plus Weightbehavior equals 1.

Next, at 346, process 300 can determine whether the score determined at 340 is in a white-list range, a gray-list range, or a black-list range. The white-list range, the gray-list range, and the black-list range can have any suitable values in some embodiments. For example, the white-list range can range from values of 67 through 100, the gray-list range can range from values of 34 through 66, and the black-list range can range from values of 0 through 33.

If process 300 determines at 346 that the score determined at 340 is in a white-list range, then, at 348, process 300 can respond to the DNS request with an EDNS option that instructs user router 114 to allow the connection corresponding to the DNS request and process 300 can add the domain to a white-list for the known type, manufacturer, and model of IoT device. In response to receiving instructions to allow the connection between the IoT device and the target domain, the user router can create a rule to allow all such connections between the IoT device and the target domain in some embodiments.

If process 300 determines at 346 that the score determined at 340 is in a gray-list range, then, at 350, process 300 can instruct the user router to inspect communications of the connection between the IoT device and the domain and provide data on the communications so that the behavioral analysis performed at 340 can use the data for future connection attempts by IoT devices from the current local network 112 or another local network.

Otherwise, if process 300 determines at 346 that the score determined at 340 is in a black-list range, then, at 352, process 300 can respond to the DNS request with an EDNS option that instructs user router 114 to drop the connection corresponding to the DNS request. In some embodiments, any suitable response can be provided to the device that issued the DNS request, such as a message indicating that the target domain has a category that is in a black-list. In response to receiving instructions to drop the connection between the IoT device and the target domain, the user router can create a rule to drop all such connections between the IoT device and the target domain in some embodiments.

After performing any of 308, 316, 324, 330, 334, 338, 348, 350, and 352, process 300 can end at 354.

It should be understood that at least some of the above described blocks of the process of FIGS. 3A and 3B can be executed or performed in any order or sequence not limited to the order and sequence shown in and described in the figure. Also, some of the above blocks of the process of FIGS. 3A and 3B can be executed or performed substantially simultaneously where appropriate or in parallel to reduce latency and processing times. Additionally or alternatively, some of the above described blocks of the process of FIGS. 3A and 3B can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, systems, methods, and media for intelligent split-tunneling are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for securing an Internet of Things (IoT) device, comprising:
a memory; and
a hardware processor that is coupled to the memory and that is configured to:
receive a DNS request identifying a fully qualified domain name (FQDN) that originated from the IoT device;
in response to receiving the DNS request, determine whether to allow or drop a connection between the IoT device and a target domain corresponding to the FQDN; and
respond to the DNS request with instructions to allow or drop the connection based on the determining.

2. The system of claim 1, wherein in determining whether to allow or drop the connection between the IoT device and the target domain corresponding to the FQDN, the hardware processor determines whether the target domain is owned by a manufacturer of the IoT device.

3. The system of claim 1, wherein in determining whether to allow or drop the connection between the IoT device and the target domain corresponding to the FQDN, the hardware processor determines a type, a manufacturer, and a model of the IoT device.

4. The system of claim 1, wherein in determining whether to allow or drop the connection between the IoT device and the target domain corresponding to the FQDN, the hardware processor determines whether a category of domains of the target domain is in a black-list.

5. The system of claim 1, wherein in determining whether to allow or drop the connection between the IoT device and the target domain corresponding to the FQDN, the hardware processor determines whether the target domain or a category of domains of the target domain is in a white-list.

6. The system of claim 1, wherein in determining whether to allow or drop the connection between the IoT device and the target domain corresponding to the FQDN, the hardware processor determines a relevance of the target domain to the IoT device.

7. The system of claim 1, wherein in determining whether to allow or drop the connection between the IoT device and the target domain corresponding to the FQDN, the hardware processor performs a behavioral analysis on the connection.

8. A method for securing an Internet of Things (IoT) device, comprising:
receiving a DNS request identifying a fully qualified domain name (FQDN) that originated from the IoT device;
in response to receiving the DNS request, determining by a hardware processor whether to allow or drop a connection between the IoT device and a target domain corresponding to the FQDN; and
responding to the DNS request with instructions to allow or drop the connection based on the determining.

9. The method of claim 8, wherein determining whether to allow or drop the connection between the IoT device and the target domain corresponding to the FQDN comprises determining whether the target domain is owned by a manufacturer of the IoT device.

10. The method of claim 8, wherein determining whether to allow or drop the connection between the IoT device and the target domain corresponding to the FQDN comprises determining a type, a manufacturer, and a model of the IoT device.

11. The method of claim 8, wherein determining whether to allow or drop the connection between the IoT device and the target domain corresponding to the FQDN comprises determining whether a category of domains of the target domain is in a black-list.

12. The method of claim 8, wherein determining whether to allow or drop the connection between the IoT device and the target domain corresponding to the FQDN comprises determining whether the target domain or a category of domains of the target domain is in a white-list.

13. The method of claim 8, wherein determining whether to allow or drop the connection between the IoT device and the target domain corresponding to the FQDN comprises determining a relevance of the target domain to the IoT device.

14. The method of claim 8, wherein determining whether to allow or drop the connection between the IoT device and the target domain corresponding to the FQDN comprises performing a behavioral analysis on the connection.

15. A non-transitory computer-readable medium containing computer executable instructions that, when executed by a processor, cause the processor to perform a method for securing an Internet of Things (IoT) device, the method comprising:
receiving a DNS request identifying a fully qualified domain name (FQDN) that originated from the IoT device;
in response to receiving the DNS request, determining whether to allow or drop a connection between the IoT device and a target domain corresponding to the FQDN; and
responding to the DNS request with instructions to allow or drop the connection based on the determining.

16. The non-transitory computer-readable medium of claim 15, wherein determining whether to allow or drop the connection between the IoT device and the target domain corresponding to the FQDN comprises determining whether the target domain is owned by a manufacturer of the IoT device.

17. The non-transitory computer-readable medium of claim 15, wherein determining whether to allow or drop the connection between the IoT device and the target domain corresponding to the FQDN comprises determining a type, a manufacturer, and a model of the IoT device.

18. The non-transitory computer-readable medium of claim 15, wherein determining whether to allow or drop the connection between the IoT device and the target domain corresponding to the FQDN comprises determining whether a category of domains of the target domain is in a black-list.

19. The non-transitory computer-readable medium of claim 15, wherein determining whether to allow or drop the connection between the IoT device and the target domain corresponding to the FQDN comprises determining whether the target domain or a category of domains of the target domain is in a white-list.

20. The non-transitory computer-readable medium of claim 15, wherein determining whether to allow or drop the connection between the IoT device and the target domain corresponding to the FQDN comprises determining a relevance of the target domain to the IoT device.
